(19) United States
(12) Patent Application Publication
(10) Pub. No.: US 2022/0417479 A1
(43) Pub. Date: Dec. 29, 2022

(54) INFORMATION PROCESSING DEVICE AND INFORMATION PROCESSING METHOD

(71) Applicant: SONY GROUP CORPORATION, Tokyo (JP)

(72) Inventor: Yu AOKI, Tokyo (JP)

(73) Assignee: SONY GROUP CORPORATION, Tokyo (JP)

(21) Appl. No.: 17/780,313

(22) PCT Filed: Nov. 18, 2020
(86) PCT No.: PCT/JP2020/042906

§ 371 Date: May 26, 2022

(30) Foreign Application Priority Data
Dec. 2, 2019 (JP) 2019-218054

(51) Int. Cl. H04N 9/31

(52) U.S. Cl. CPC H04N 9/3185; H04N 9/3194

(57) ABSTRACT

There is provided an information processing device and an information processing method which are capable of setting a projection plane in a more appropriate form. The information processing device includes a registration unit configured to register display control information for displaying display information on a projection plane, the display control information being generated based on sensor data obtained from a sensor provided in first equipment installed at the projection plane, and a display control unit configured to project the display information onto the projection plane and display the display information based on the display control information. The present technology can be applied to a projection system that displays information by projection.

### TECHNICAL FIELD

The present technology relates to an information processing device and an information processing method, and more particularly, to an information processing device and an information processing method which are capable of setting a projection plane in a more appropriate form.

### BACKGROUND ART

In recent years, research has been conducted on augmented reality (AR) technology such as technology for presenting information by projection and performing an operation using a projection plane or projection AR technology for expanding a real space using projection mapping.

In a case where information is displayed to be superimposed on a real object by projection, or information is displayed on a plane on which a real object is installed, it is common to estimate the posture of a real object or a projection plane based on pre-registered images of real objects, geometric information such as feature points, and three-dimensional information, using images captured by a stationary camera.

For example, PTL 1 discloses technology in which a video presentation device calculates a positional relationship between video presentation devices, based on the position of an infrared light emitting diode (LED) provided in another video presentation device.

### CITATION LIST

### Patent Literature

[PTL 1]

JP 2016-46731 A

### SUMMARY

### Technical Problem

However, in a case where the position of a real object or the like is estimated using an image captured by a stationary camera, there is a possibility that the accuracy of estimation will be decreased due to a positional relationship between the camera and the real object or the postures thereof. In addition, there is a possibility that the accuracy of estimation of the posture of a real object away from the camera will be decreased due to the resolution of the camera.

In addition, attaching an infrared light marker such as an infrared LED to a real object is complicated.

For this reason, there has been a demand for technology for setting a projection plane by estimating the posture and position of the projection plane in a more appropriate form by using images captured by a camera.

The present technology is contrived in view of such circumstances, and makes it possible to set a projection plane in a more appropriate form.

### Solution to Problem

An information processing device according to an aspect of the present technology is an information processing device including a registration unit configured to register display control information for displaying display information on a projection plane, the display control information being generated based on sensor data obtained from a sensor provided in first equipment installed at the projection plane, and a display control unit configured to project the display information onto the projection plane and display the display information based on the display control information.

An information processing method according to an aspect of the present technology is an information processing method including causing an information processing device to register display control information for displaying display information on a projection plane, the display control information being generated based on sensor data obtained from a sensor provided in first equipment installed at the projection plane, and project the display information onto the projection plane and display the display information based on the display control information.

In the aspect of the present technology, display control information for displaying display information on a projection plane is registered, the display control information being generated based on sensor data obtained from a sensor provided in first equipment installed at the projection plane, and the display information is projected and displayed on the projection plane based on the display control information.

### BRIEF DESCRIPTION OF DRAWINGS

FIG. 1 is a diagram showing a configuration example of a projection system according to an embodiment of the present technology.

FIG. 2 is a diagram showing a method of registering information on registration target equipment and a projection plane.

FIG. 3 is a diagram showing a flow of projection of display information of electrical equipment.

FIG. 4 is a diagram showing an example of a method of estimating the position and posture of a real object.

FIG. 5 is a diagram showing another example of a method of estimating the position and posture of a real object.

FIG. 6 is a diagram showing still another example of a method of estimating the position and posture of a real object.

FIG. 7 is a diagram showing an example of a method of estimating the position and posture of a projection plane in the present technology.

FIG. 8 is a diagram showing an example of an angle of view of imaging of an infrared stereo camera.

FIG. 9 is a block diagram showing a configuration example of a portable terminal.

FIG. 10 is a diagram showing an example of calculation of the posture of a portable terminal.

FIG. 11 is a block diagram showing a configuration example of an information processing device.

FIG. 12 is a diagram showing a schema example of an installation information database.

FIG. 13 is a diagram showing an example of imaging of a flashing pattern of infrared light.

FIG. 14 is a diagram showing an example of a depth image.

FIG. 15 is a diagram showing an example of a method of designating a region by combining a plurality of points.

FIG. 16 is a diagram showing an example of an image in which a plurality of depth images are superimposed on each other.

FIG. 17 is a flowchart illustrating registration processing for a portable terminal.

FIG. 18 is a flowchart illustrating registration processing for an information processing device.

FIG. 19 is a flowchart illustrating projection processing for the information processing device.

FIG. 20 is a diagram showing another schema example of an installation information database.

FIG. 21 is a block diagram showing a configuration example of a projector.

FIG. 22 is a block diagram showing a configuration example of hardware of a computer.

### DESCRIPTION OF EMBODIMENTS

An embodiment of the present technology will be described below. Description will be given in the following order.

1. Description of outline of projection system

2. Detection of position and posture of projection plane

3. Configuration of each piece of equipment

4. Operation of each piece of equipment

5. Modification example

<1. Description of Outline of Projection System>

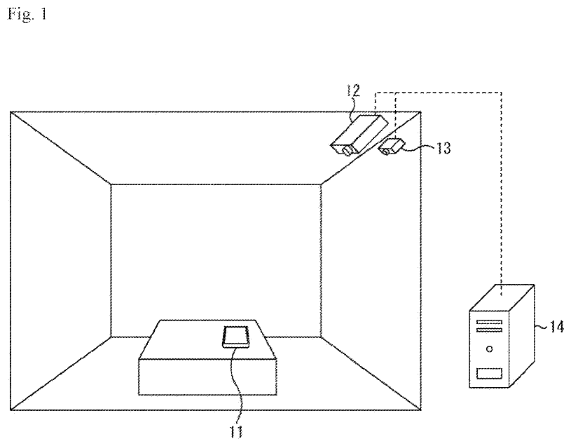

FIG. 1 is a diagram showing a configuration example of a projection system according to an embodiment of the present technology.

As illustrated in FIG. 1, the projection system includes a portable terminal 11, a projector 12, an infrared stereo camera 13, and an information processing device 14.

The portable terminal 11 is constituted by equipment such as a smartphone or a tablet terminal. The portable terminal 11 is provided with a posture sensor that detects the posture of the portable terminal 11 and an infrared light source that outputs infrared light.

The portable terminal 11 is placed on a projection plane such as a wall surface, a table surface, or a floor surface onto which a display image showing display information is projected by the projector 12. In the example of FIG. 1, the portable terminal 11 is placed on a table in an installation space such as a room provided with components, such as the projector 12, which constitute the projection system. The portable terminal 11 detects its own posture using the posture sensor, and registers information indicating the detected posture in the information processing device 14 as information indicating the posture of a projection plane.

The projector 12 is a projection device that projects a display image indicating various display information onto the projection plane. The projector 12 is installed at a position where a display image can be projected onto a projection plane formed on a wall surface, a table surface, or the like in the installation space. In the example of FIG. 1, the projector 12 is installed on a ceiling in the room. The projector 12 displays the display image by projecting the display image under the control of the information processing device 14.

The infrared stereo camera 13 is an imaging device that generates a depth image by detecting infrared light. The infrared stereo camera 13 is installed at a position where the projection plane of the projector 12 can be imaged. In the example of FIG. 1, the infrared stereo camera 13 is installed at a position in the vicinity of the projector 12.

For example, the infrared stereo camera 13 detects infrared light output by an infrared light source provided in the portable terminal 11 to generate a depth image. The depth image is used to perform measurement of a distance between the portable terminal 11 and the infrared stereo camera 13, and the like in the information processing device 14.

The information processing device 14 is constituted by, for example, a personal computer (PC) or dedicated equipment. The information processing device 14 can also be referred to as a server device that manages an installation information database in which display control information is registered. The display control information is information including installation information indicating the position and posture of the projection plane. In the example of FIG. 1, the information processing device 14 is installed outside the room.

The portable terminal 11 and the information processing device 14 are connected to each other through a network such as the Internet or a wireless local area network (LAN), and can exchange information with each other. The projector 12 and the infrared stereo camera 13 are connected to the information processing device 14 through wired or wireless communication.

A user of the projection system having such a configuration can register information on registration target equipment and information on any projection plane in the installation information database of the information processing device 14 in association with each other by using the portable terminal 11.

As the registration target equipment, equipment capable of acquiring display information desired to be projected by the projector 12 is selected from among various pieces of equipment such as equipment (electrical equipment or the like) installed in an installation space or equipment (electrical equipment or the like) brought into the installation space from the outside. Display information is appropriately projected onto a projection plane registered in the installation information database by the projector 12. The display information is information which is acquired by the registration target equipment and projected by the projector 12.

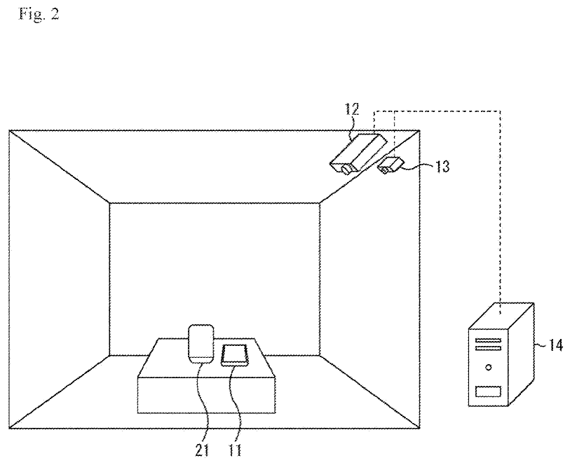

FIG. 2 is a diagram showing a method of registering information on registration target equipment and a projection plane.

In the example of FIG. 2, electrical equipment 21 located on a table on which the portable terminal 11 is placed is selected as registration target equipment. In the example of FIG. 2, the electrical equipment 21 is a smart speaker, and it is assumed that the electrical equipment 21 is reproducing music or sound of a radio program received from a distribution server via the Internet.

The portable terminal 11 and the electrical equipment 21 have a function corresponding to the standard of proximity wireless communication such as near field communication (NFC) communication. When a user holds the portable terminal 11 over the electrical equipment 21, the portable terminal 11 performs NFC communication (proximity wireless communication) with the electrical equipment 21 to acquire equipment information of the electrical equipment 21. The equipment information is information including network information such as an equipment name, the type of equipment, and an Internet Protocol (IP) address.

The user holds the portable terminal 11 over the electrical equipment 21 and then moves the portable terminal 11 to a position where information of the electrical equipment 21 is desired to be projected. Information is exchanged between the portable terminal 11 and the information processing device 14, and thus a surface on which the portable terminal 11 is placed is registered in the information processing device 14 as a projection plane onto which information of the electrical equipment 21 is projected. Information transmitted to the information processing device 14 from the portable terminal 11 includes equipment information of the electrical equipment 21 which is acquired by NFC communication.

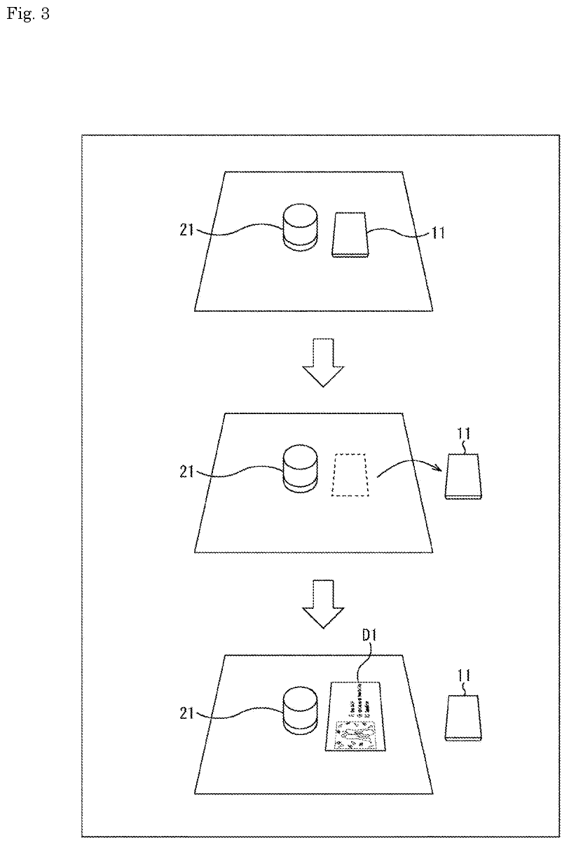

FIG. 3 is a diagram showing a flow of projection of display information of the electrical equipment 21. In FIG. 3, the flow of projection of the display information is shown in time series in the order of an upper section, a middle section, and a lower section.

In the upper section of FIG. 3, the electrical equipment 21 is placed at substantially the center of a table surface, and the portable terminal 11 is placed on the right side of the electrical equipment 21. In such a state, for example, the table surface on which the portable terminal 11 is placed is registered in the installation information database of the information processing device 14 as a projection plane for information of the electrical equipment 21.

After the display control information is registered, the user moves the portable terminal 11 from the table surface to another place as shown in the middle section of FIG. 3.

In addition, after the display control information is registered, for example, information of music being reproduced is transmitted from the electrical equipment 21 to the information processing device 14 as display information. The information processing device 14 and the electrical equipment 21 are also connected to each other through a network.

In the information processing device 14, music information transmitted from the electrical equipment 21 is received, and processing for projecting a display image for displaying the music information onto the projector 12 is performed based on the display control information.

In a region D1 which is a region including a position where the portable terminal 11 is placed, the display information of the electrical equipment 21 is projected by the projector 12 as shown in the lower section of FIG. 3. In the lower section of FIG. 3, a thumbnail image, artist information, the title of music, and the like are projected as music information.

Thereby, the user can designate a region serving as a projection plane for display information of another piece of equipment by placing the portable terminal 11 at a desired position. In addition, the user can visually confirm the display information of another piece of equipment by a display image projected by the projector 12.

Although a case where display information is projected onto a region including a position where the portable terminal 11 is placed has been described above, it is possible to project display information with regions at various positions determined based on the position of the portable terminal 11 as a projection plane. That is, it is possible to set a region including a position deviated from a region including the position where the portable terminal 11 is placed as a projection plane with respect to the position.

<2. Detection of Position and Posture of Projection Plane>

Examples of a method of implementing augmented reality (AR) for displaying information on a real object to be superimposed on the real object or displaying information on a plane on which a real object is installed include a head-mounted display method, a method of displaying information in a so-called camera-through manner, a method of displaying information by a projector, and the like.

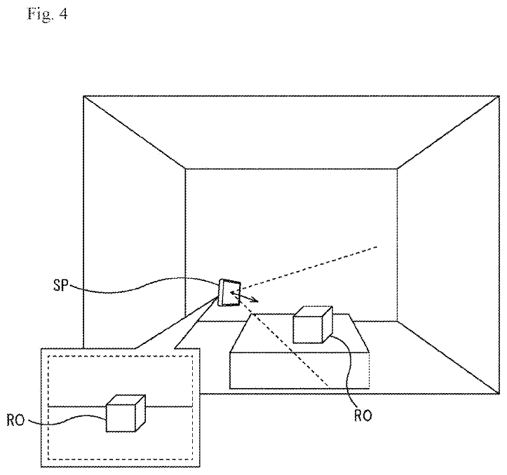

In a case where AR is implemented by each of the methods, the position and posture of a projection plane are estimated. Here, a method of estimating the positions and postures of various projection planes and a method of estimating the position and posture of a projection plane in the present technology described above will be described with reference to FIGS. 4 to 8.

FIG. 4 is a diagram showing an example of a method of estimating the position and posture of a real object.

The estimation method shown in FIG. 4 is a method of estimating the position and posture of a real object which is performed in a case where information is displayed in a camera-through manner.

A smartphone SP implementing AR in a camera-through manner is provided with a camera that images a real object RO installed on a table surface in an installation space, and a display that displays an image captured by the camera.

For example, as shown in balloons of FIG. 4, an image in which the real object RO is shown is captured by the camera of the smartphone SP. The position and posture of the real object RO are estimated based on such an image.

In the smartphone SP used in the estimation method, a camera which is an input device and a display which is an output device are provided in the same housing, and thus a user can change the direction of the camera and a distance from the real object in accordance with the real object RO. For example, information on the real object RO is displayed on the display of the smartphone SP so as to be superimposed on the real object RO, based on estimation results of the position and posture of the real object RO.

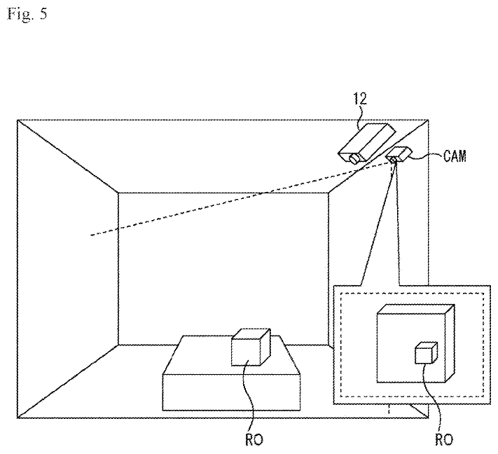

FIG. 5 is a diagram showing another example of a method of estimating the position and posture of a real object.

The estimation method shown in FIG. 5 is a method of estimating the position and posture of a real object which is performed in a case where information is displayed by a projector.

As shown in FIG. 5, in the method of displaying information by a projector, a camera CAM that images the real object RO is installed at a ceiling in a room, or the like, unlike the method described with reference to FIG. 4.

As shown in balloons of FIG. 5, an image in which the real object RO and a table are shown is captured by the camera CAM. The position and posture of the real object RO are estimated based on such an image.

However, since it is difficult to change the position of the camera CAM in accordance with the real object RO, there is a possibility that the accuracy of estimation of the position and posture of the real object RO will be decreased due to a positional relationship between the camera CAM and the real object RO, or the like.

Further, in a case where the camera CAM images a wide space, there is a possibility that the accuracy of estimation of the position and posture of the real object RO separated from the camera CAM will be decreased due to the resolution of the camera CAM.

The projector 12 installed at a ceiling in a room displays, for example, information on the real object RO so as to be superimposed on the real object RO, based on estimation results of the position and posture of the real object RO.

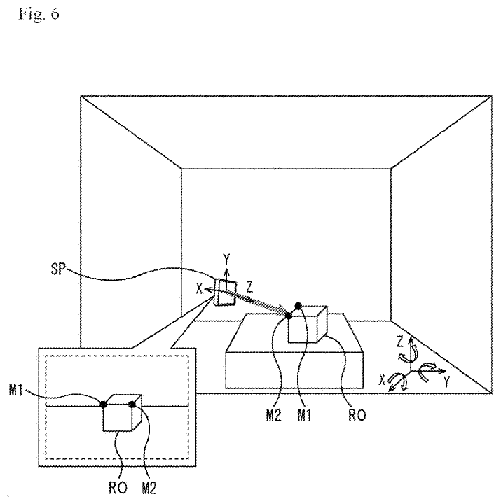

FIG. 6 is a diagram showing still another example of a method of estimating the position and posture of a real object.

The estimation method shown in FIG. 6 is a method of estimating the position and posture of a real object which is performed in a case where information is displayed in a camera-through manner.

Markers M1 and M2, which are two markers, are attached to the vertices of a rectangular parallelepiped forming the real object RO imaged by the camera of the smartphone SP.

As shown in balloons of FIG. 6, an image in which the real object RO and the markers M1 and M2 are shown is captured by the camera of the smartphone SP. A positional relationship between the smartphone SP and the real object RO is calculated based on the positions of the markers M1 and M2 in such an image and information indicating the postures of the smartphone SP and the real object RO.

Th smartphone SP can display information even when the real object RO is not included in an angle of view of the camera, based on the positional relationship between the smartphone SP and the real object RO.

Attaching the markers M1 and M2 to the real object RO is complicated. For this reason, the markers can also be displayed on a display provided in the real object RO.

However, in a case where the positions of the markers are detected using an image captured by a camera provided at a ceiling or the like, there is a possibility that the accuracy of detection of the markers will be decreased due to an installation position of the camera or a distance from the real object RO.

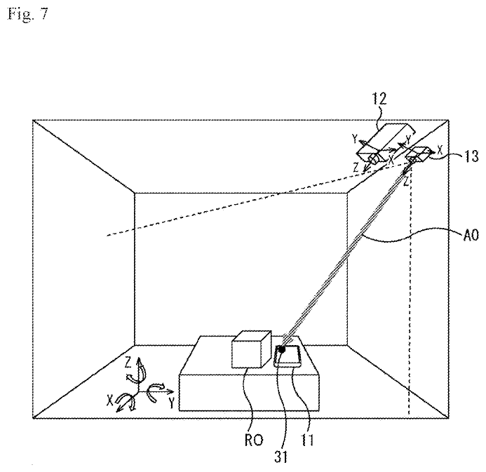

FIG. 7 is a diagram showing an example of a method of estimating the position and posture of a projection plane in the present technology.

As shown in FIG. 7, the portable terminal 11 placed next to the real object RO as registration target equipment is provided with an infrared light source 31. The portable terminal 11 is also provided with a posture sensor. Note that, the real object RO is equivalent to the electrical equipment 21 of the above-mentioned smart speaker or the like.

The portable terminal 11 estimates the posture of a projection plane in a world coordinate system using a posture sensor and outputs infrared light from the infrared light source 31.

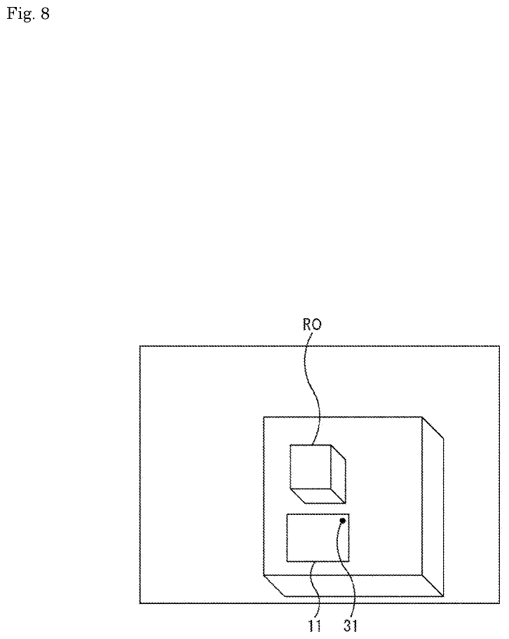

The infrared stereo camera 13 images an installation space and generates a depth image. An angle of view of imaging of the infrared stereo camera 13 includes the real object RO, the portable terminal 11, and the table as shown in FIG. 8. In the depth image generated by the infrared stereo camera 13, the real object RO and the portable terminal 11 that are placed on the table are shown.

The depth image generated by the infrared stereo camera 13 is supplied to the information processing device 14. Information on the posture of the projection plane estimated using the posture sensor of the portable terminal 11 is also transmitted to the information processing device 14.

The information processing device 14 calculates a vector directed to the position of the infrared light source 31 from the installation position of the infrared stereo camera 13 by using the depth image supplied from the infrared stereo camera 13. A colored arrow A0 in FIG. 7 indicates a vector directed to the position of the infrared light source 31 from the installation position of the infrared stereo camera 13.

In addition, the information processing device 14 estimates the position of the infrared light source 31 based on the vector. The position of the infrared light source 31 is registered as the position of the projection plane, together with the posture of the projection plane which is estimated by the portable terminal 11.

That is, it can be said that the portable terminal 11 provided with the infrared light source 31 and the posture sensor functions as an installation information acquisition device that acquires the position and posture of the projection plane.

In this manner, in the method of estimating the position and posture of the projection plane using the installation information acquisition device, the installation information acquisition device is provided as a device of a housing separate from the projector 12 and the infrared stereo camera 13. Since the projector 12 and the infrared stereo camera 13 are provided in a separate housing, processing for converting a coordinate system of the position and posture of the projection plane acquired by the installation information acquisition device into a projector coordinate system is performed.

As described above, in the projection system of the present technology, the position and posture of a projection plane are estimated by combining position detection using infrared light output by the infrared light source 31 and posture estimation using a posture sensor.

Thereby, it is possible to curb a decrease in the accuracy of estimation of the position and posture of a projection plane due to a positional relationship with the projection plane, or the like, in which the decrease in the accuracy of estimation may occur in a case where a camera fixed to a ceiling or the like is used. In addition, it is possible to curb a decrease in the accuracy of estimation of the position and posture of the projection plane due to the resolution of the camera.

Further, since there is no high-load processing such as object recognition using an image captured by the camera, it is possible to acquire the position and posture of a projection plane and realize the projection of information according to the projection plane even in a device with low specifications.

As a result, it is possible to detect the posture and position of a projection plane in a more appropriate form by using an image captured by a camera. Thus, it is possible to set a projection plane in a more appropriate form.

Further, in a case where the electrical equipment 21 serving as registration target equipment is equipment such as a home appliance having no information display function, the projection system can provide an information display function based on projection, instead of registration target equipment.

<3. Configuration of Each Piece of Equipment>

Configuration of Portable Terminal 11

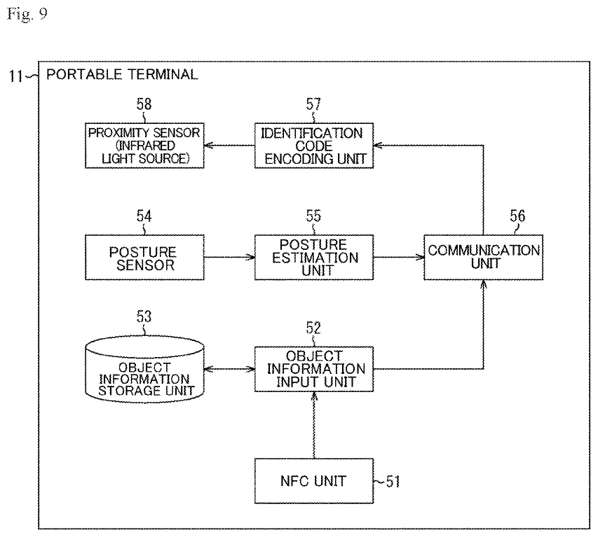

FIG. 9 is a block diagram showing a configuration example of the portable terminal 11. At least some of the functional units shown in FIG. 9 are implemented by executing a predetermined program by a central processing unit (CPU) or the like provided in the portable terminal 11.

As shown in FIG. 9, the portable terminal 11 includes an NFC unit 51, an object information input unit 52, an object information storage unit 53, a posture sensor 54, a posture estimation unit 55, a communication unit 56, an identification code encoding unit 57, and a proximity sensor 58.

The NFC unit 51 is, for example, a reader/writer for NFC communication. The NFC unit 51 performs NFC communication with registration target equipment to acquire equipment information of the registration target equipment. The equipment information of the registration target equipment is supplied to the object information input unit 52.

The object information input unit 52 supplies equipment information supplied from the NFC unit 51 to the communication unit 56. In addition, the object information input unit 52 supplies the equipment information to the object information storage unit 53 and stores the information therein.

The object information storage unit 53 stores the equipment information acquired from the registration target equipment. The object information storage unit 53 is constituted by an auxiliary storage device including an internal or external storage such as a semiconductor memory.

The posture sensor 54 is constituted by various sensors such as an acceleration sensor, a gyro sensor, and a geomagnetic sensor. Note that the acceleration sensor and the gyro sensor are collectively referred to as an inertial sensor (Inertial Measurement Unit: IMU). The posture sensor 54 detects an angular velocity, an acceleration, a magnetic field strength, and the like of the portable terminal 11, and supplies sensor data indicating detection results to the posture estimation unit 55.

The posture estimation unit 55 calculates the posture of the portable terminal 11 in a world coordinate system, based on sensor data indicating the detection results supplied from the posture sensor 54. Processing of calculating the posture of the portable terminal 11 is started after equipment information is acquired from the registration target equipment by the NFC unit 51.

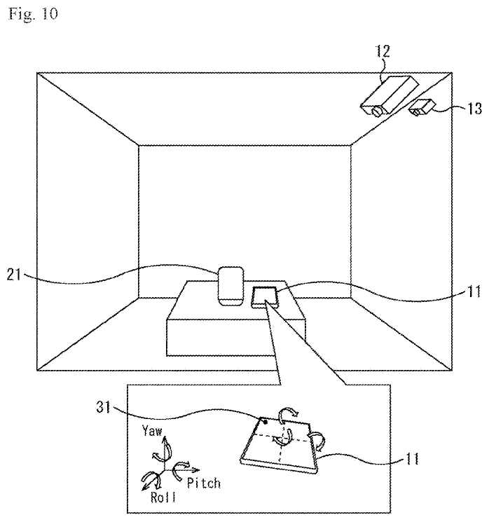

FIG. 10 is a diagram showing an example of calculation of the posture of the portable terminal 11.

As shown in FIG. 10, the calculation of the posture of the portable terminal 11 is performed while the portable terminal 11 is placed on the projection plane after the equipment information of the electrical equipment 21 which is registration target equipment is acquired.

First, in the posture estimation unit 55, the posture of the portable terminal 11 is estimated based on an angular velocity of the portable terminal 11 which is detected by the gyro sensor. Then, in the posture estimation unit 55, the posture of the portable terminal 11 which is estimated based on a detection result of the gyro sensor is corrected using the posture of the portable terminal 11 which is estimated based on an acceleration value of the portable terminal 11 which is detected by the acceleration sensor and a magnetic field strength detected by the geomagnetic sensor.

Note that the posture of the portable terminal 11 may be estimated using only a detection result of the acceleration sensor or only a detection result of the geomagnetic sensor.

The posture of the portable terminal 11 which is estimated by the posture estimation unit 55 is indicated by rotation around three axes, that is, a pitch axis (X axis), a low axis (Y axis), and a yaw axis (Z axis) as shown in balloons of FIG. 10.

Referring back to FIG. 9, the posture estimation unit 55 fixedly decides information indicating the posture of the portable terminal 11 as posture information and supplies the posture information to the communication unit 56 in a case where a state where the amount of change in posture is equal to or less than a predetermined threshold value has continued for a fixed period of time. The posture information is information indicating the posture of the projection plane in the world coordinate system.

Note that the posture information includes offset information which is information from the proximity sensor 58 having the infrared light source 31 mounted thereon to the center of a rotation axis of the posture of the portable terminal 11. In addition, the posture information may be generated by the information processing device 14 by transmitting sensor data indicating a detection result to the information processing device 14.

The communication unit 56 is constituted by a communication module or the like that supports wireless communication such as wireless LAN (for example, Wi-Fi (registered trademark)) or cellular type communication (for example, LTE-Advanced or 5G), or wired communication such as Ethernet (registered trademark). The communication unit 56 transmits the equipment information supplied from the object information input unit 52 and the posture information supplied from the posture estimation unit 55 to the information processing device 14.

In addition, the communication unit 56 receives an identification code, which is to be described later, transmitted from the information processing device 14, and supplies the received identification code to the identification code encoding unit 57.

The identification code encoding unit 57 encodes the identification code supplied from the communication unit 56 into a flashing pattern. The identification code encoding unit 57 supplies information indicating the flashing pattern to the proximity sensor 58.

The proximity sensor 58 is provided with the infrared light source 31 that emits infrared light to a measurement object, and a light receiving element that receives infrared light reflected by the measurement object. The proximity sensor 58 outputs a flashing pattern of infrared light which is an encoded identification code, by using the infrared light source 31 such as a light emitting diode (LED).

Configuration of Information Processing Device 14

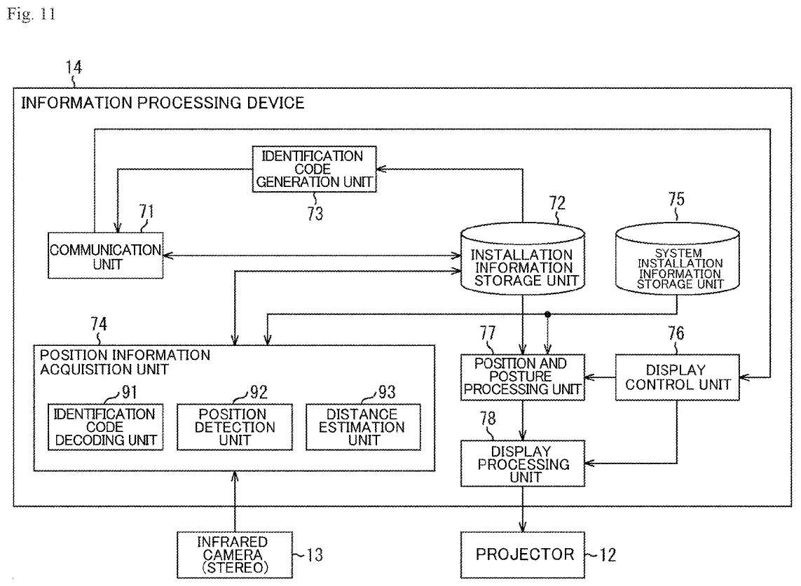

FIG. 11 is a block diagram showing a configuration example of the information processing device 14. At least some of the functional units shown in FIG. 11 are implemented by executing a predetermined program by a CPU or the like provided in the information processing device 14.

As shown in FIG. 11, the information processing device 14 includes a communication unit 71, an installation information storage unit 72, an identification code generation unit 73, a position information acquisition unit 74, a system installation information storage unit 75, a display control unit 76, a position and posture processing unit 77, and a display processing unit 78.

The communication unit 71 is constituted by a communication module or the like that supports wireless communication such as wireless LAN (for example, Wi-Fi) or cellular type communication (for example, LTE-Advanced or 5G), or wired communication such as Ethernet. The communication unit 71 transmits an identification code supplied from the identification code generation unit 73 to the portable terminal 11.

In addition, the communication unit 71 receives display information transmitted from registration target equipment, and supplies the received display information to the display control unit 76 together with information indicating equipment which is a providing source of display information. For example, the communication unit 71 receives music information transmitted from the smart speaker as the electrical equipment 21 which is registration target equipment, and supplies the received music information to the display control unit 76 together with network information of the smart speaker.

The communication unit 71 also receives the equipment information and the posture information transmitted from the portable terminal 11. The communication unit 71 supplies the equipment information and the posture information to the installation information storage unit 72 and stores the information therein. The installation information storage unit 72 is constituted by an auxiliary storage device including an internal or external storage such as a semiconductor memory or a hard disk drive (HDD).

In the installation information storage unit 72, the equipment information and the posture information supplied from the communication unit 71, and the position information supplied from the position information acquisition unit 74 are registered in the installation information database in association with each other as display control information. That is, the communication unit 71 and the position information acquisition unit 74 function as a registration unit that register display control information in the installation information database. The position information is information indicating the position of a projection plane in a world coordinate system.

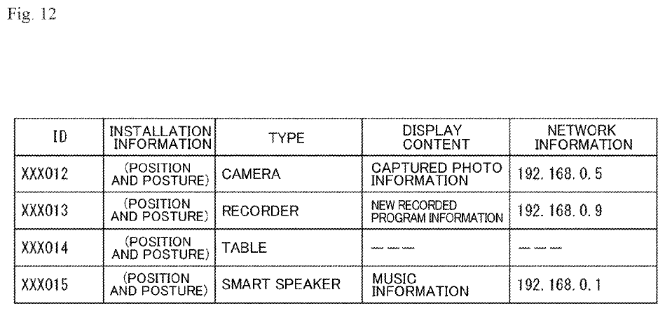

FIG. 12 is a diagram showing a schema example of an installation information database.

In FIG. 12, an “ID”, “installation information”, a “type”, a “display content”, and “network information” are associated with each other. The “ID” is an ID given to identify registration target equipment. The “installation information” is information including position information and posture information of a projection plane. The “type” is information indicating the type of registration target equipment and determined based on equipment information. The “display content” is information indicating the type of display information which is information projected onto a projection plane.

For example, for ID XXX012, information on a projection plane onto which a captured image acquired by a camera is projected as display information is registered. Registration target equipment being the camera, position information and posture information of the projection plane and display information being captured photo information, and an IP address being 192.168.0.5 are associated with each other.

Thus, for the projection plane associated with ID XXX012, a display image indicating captured photo information transmitted through a network from the camera having an IP address being 192.168.0.5 is projected. The captured photo information is information of a captured image acquired by the camera.

For ID XXX013, information on a projection plane onto which recording information acquired by a recorder is projected as display information is registered. Registration target equipment being the recorder, position information and posture information of the projection plane and display information being new recorded program information, and an IP address being 192.168.0.9 are associated with each other.

Thus, for the projection plane associated with ID XXX013, a display image indicating new recorded program information transmitted through a network from the recorder having an IP address being 192.168.0.9 is projected. The new recorded program information is information indicating a new program recorded by the recorder.

For ID XXX014, information on a projection plane formed in a table is registered. Registration target equipment being the table, and position information and posture information of the projection plane are associated with each other. For example, in a case where the table has no function of transmitting information to the information processing device 14, display information and network information are not registered for ID XXX014.

The table as registration target equipment is registered as projection planes of various information. For example, for the table associated with ID XXX014, a display image indicating collective information of various pieces of equipment is projected.

Note that equipment information of equipment having no communication function such as a table can be input by a user by using the portable terminal 11.

For ID XXX015, information on a projection plane onto which music information acquired by the smart speaker is projected as display information is registered. Registration target equipment being the smart speaker, position information and posture information of the projection plane, and display information being music information, and an IP address being 192.168.0.1 are associated with each other.

Thus, for the projection plane associated with ID XXX015, a display image indicating music information transmitted through a network from the smart speaker as the electrical equipment 21 having an IP address being 192.168.0.1 is projected.

Referring back to FIG. 11, the identification code generation unit 73 acquires key information stored in the installation information storage unit 72. The key information is information including a main key such as an ID.

The identification code generation unit 73 generates an identification code based on the key information. The identification code is information by which registration target equipment is identifiable. In the installation information database, a unique ID is set for the registration target equipment, and thus an identification code is a unique code.

The identification code generated by the identification code generation unit 73 is supplied to the communication unit 71 and is transmitted to the portable terminal 11. Note that the identification code is also supplied to and stored in the installation information storage unit 72. As described above, in the portable terminal 11, the identification code is encoded and is output as a flashing pattern of infrared light.

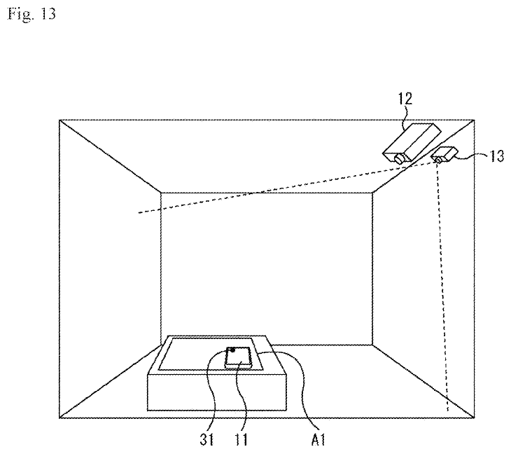

FIG. 13 is a diagram showing an example of imaging of a flashing pattern of infrared light.

As illustrated in FIG. 13, a flashing pattern of infrared light emitted from the infrared light source 31 of the portable terminal 11 having received an identification code is imaged by the infrared stereo camera 13. For example, a depth image in which a region A1 in the region of the table surface having the portable terminal 11 placed thereon is shown is captured, the region A1 being a region including the position of the infrared light source 31.

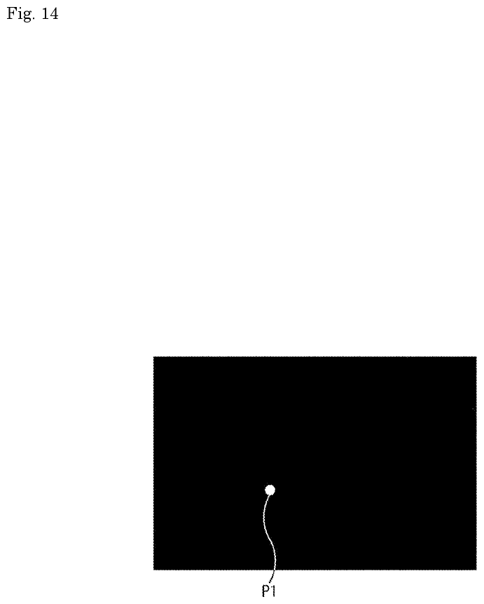

FIG. 14 is a diagram showing an example of a depth image.

For example, as shown in FIG. 14, a depth image in which a point P1 is shown is captured by the infrared stereo camera 13. The point P1 is a bright spot at which infrared light output by the infrared light source 31 of the portable terminal 11 is shown.

Such a depth image is supplied to the position information acquisition unit 74 in FIG. 11 from the infrared stereo camera 13.

The position information acquisition unit 74 acquires system installation information stored in the system installation information storage unit 75. The system installation information is information including an internal parameter and an external parameter of the projector 12, and an internal parameter and an external parameter of the infrared stereo camera 13.

The position information acquisition unit 74 generates position information of a projection plane based on the depth image supplied from the infrared stereo camera 13 and the system installation information acquired from the system installation information storage unit 75.

As shown in FIG. 11, the position information acquisition unit 74 includes an identification code decoding unit 91, a position detection unit 92, and a distance estimation unit 93.

The identification code decoding unit 91 detects a flashing pattern of infrared light based on a video as a depth image. An identification code is decoded from the flashing pattern of infrared light by the identification code decoding unit 91.

The position detection unit 92 detects the position (coordinate value) of a bright spot of infrared light in the depth image through bright spot detection. Specifically, coordinates of the center of gravity of the bright spot of infrared light are acquired.

The distance estimation unit 93 calculates a distance (depth value) from a position where the infrared stereo camera 13 is installed to the position of the bright spot detected by the position detection unit 92, based on a brightness value of the depth image.

Since the coordinates of the center of gravity of the bright spot detected by the position detection unit 92 are an image coordinate system in the infrared stereo camera 13, the position information acquisition unit 74 calculates a vector toward a bright point in a camera coordinate system using internal parameters of the infrared stereo camera 13.

The position information acquisition unit 74 calculates the position of the infrared light source 31 in the camera coordinate system, based on the vector toward the bright spot in the camera coordinate system and a distance between the infrared stereo camera 13 and the bright spot which is calculated by the distance estimation unit 93.

In addition, the position information acquisition unit 74 transforms the position of the infrared light source 31 in the camera coordinate system into the position of the infrared light source 31 in the world coordinate system, based on the external parameters of the infrared stereo camera 13.

The position information acquisition unit 74 acquires an identification code stored in the installation information storage unit 72. The position information acquisition unit 74 specifies registration target equipment based on the identification code decoded by the identification code decoding unit 91. The position information acquisition unit 74 supplies information indicating the position of the infrared light source 31 in the world coordinate system to the installation information storage unit 72 as position information of the projection plane and stores the information therein.

In the installation information database, the position information is registered in association with equipment information of registration target equipment specified by the identification code.

In the system installation information storage unit 75, system installation information including the internal parameters, the external parameters, and the like of the projector 12 is stored. The system installation information storage unit 75 is constituted by an auxiliary storage device which is the same as or different from the installation information storage unit 72.

Note that it is assumed that the internal parameters of the projector 12 and the position and posture (external parameters) thereof in the world coordinate system, and the internal parameters of the infrared stereo camera 13 and the position and posture (external parameters) thereof in the world coordinate system are already known.

The display control unit 76 controls the projection of display information, based on information supplied from the communication unit 71. The display control unit 76 supplies display information supplied from the communication unit 71 to the display processing unit 78. In addition, the display control unit 76 supplies information indicating equipment, which is a providing source of display information, to the position and posture processing unit 77.

The position and posture processing unit 77 acquires display control information associated with equipment, which is a providing source of display information, from the installation information storage unit 72 based on the information supplied from the display control unit 76. In addition, the position and posture processing unit 77 acquires system installation information stored in the system installation information storage unit 75.

The position and posture processing unit 77 calculates a matrix for transforming a world coordinate system into a projector coordinate system, based on the position information and the posture information in the world coordinate system which are included in the display control information, and the external parameters of the projector 12 included in the system installation information. In addition, the position and posture processing unit 77 calculates a matrix for transforming a projector coordinate system into a projector image coordinate system, based on the internal parameters of the projector 12 included in the system installation information.

Display transformation matrices which are two matrices calculated by the position and posture processing unit 77 are supplied to the display processing unit 78.

The display processing unit 78 generates a display image indicating display information supplied from the display control unit 76. In addition, the display processing unit 78 transforms the display image into a display image of a projector image coordinate system by using the display transformation matrices supplied from the position and posture processing unit 77. The display processing unit 78 supplies the display image of the projector image coordinate system to the projector 12 and projects the display image.

Although a case where a display image is projected onto a region based on the position of one point at which the infrared light source 31 is present has been described above, a display image may be projected onto a region where a plurality of points are formed in combination.

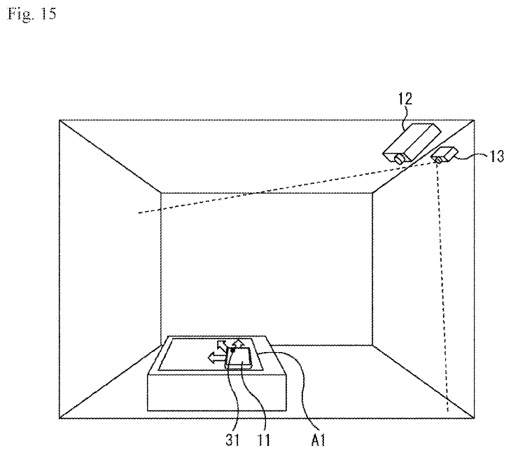

FIG. 15 is a diagram showing an example of a method of estimating a region by combining a plurality of points.

As shown in FIG. 15, a user can move the portable terminal 11 to a plurality of positions in any direction (for example, an arrow direction in the drawing) inside the region A1 which is a region of an angle of view of imaging of the infrared stereo camera 13.

The infrared stereo camera 13 captures a depth image in which infrared light output by the infrared light source 31 is shown at the positions to which the portable terminal 11 is moved, and supplies the captured depth image to the information processing device 14.

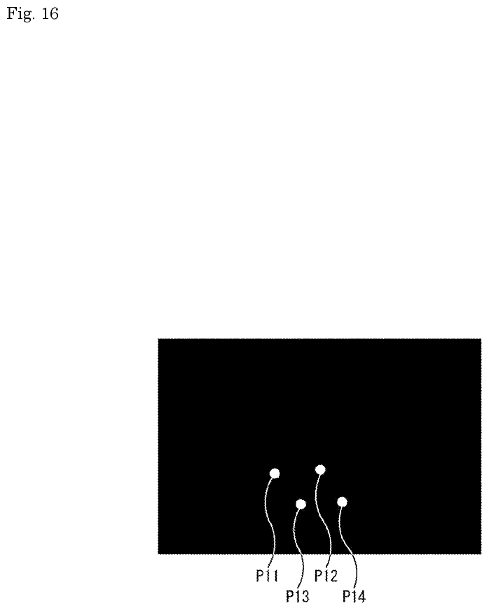

FIG. 16 is a diagram showing an example of an image in which a plurality of depth images are superimposed on each other.

In the example of FIG. 16, four depth images are captured while the portable terminal 11 is moved, and the four depth images are superimposed on each other.

The information processing device 14 detects bright spots of infrared light which is shown in the four depth images supplied from the infrared stereo camera 13, and detects bright spots of points P11 to P14, for example, as shown in FIG. 16.

In this case, the information processing device 14 registers a region formed by connecting the points P11 to P14 by a straight line in the installation information database as position information of a projection plane. When display information is projected, a display image is projected after being subjected to transformation such as enlargement or reduction so that the display image fits inside the region registered as the position information.

<4. Operation of Each Piece of Equipment>

Here, the operation of each equipment having the above-described configuration will be described.

Operation of Portable Terminal 11

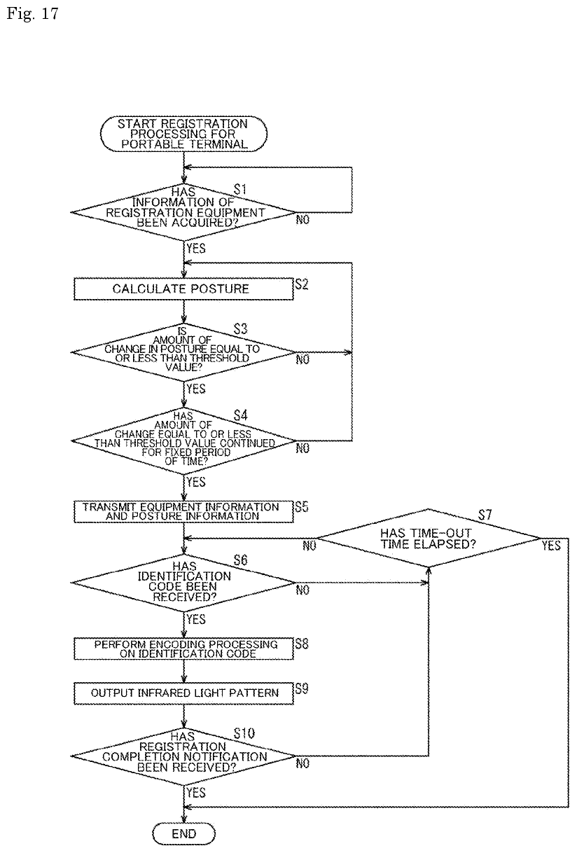

First, registration processing of the portable terminal 11 will be described with reference to a flowchart of FIG. 17.

The registration processing in FIG. 17 is a series of processing for registering posture information and position information in the information processing device 14.

In step S1, the object information input unit 52 determines whether equipment information of registration target equipment has been acquired, and waits until it is determined that the equipment information has been acquired. For example, when a user holds the portable terminal 11 over registration target equipment such as the smart speaker as the electrical equipment 21, the NFC unit 51 performs NFC communication with the registration target equipment, and in a case where equipment information has been acquired, it is determined that the equipment information has been acquired.

In a case where it is determined in step S1 that equipment information has been acquired, the processing proceeds to step S2. In step S2, the posture estimation unit 55 acquires sensor data from the posture sensor 54 and calculates the posture of the portable terminal 11 based on the sensor data.

In step S3, the posture estimation unit 55 determines whether the amount of change in the posture of the portable terminal 11 is equal to or less than a threshold value, and repeatedly calculates the posture of the portable terminal 11 until the amount of change in the posture of the portable terminal 11 is equal to or less than the threshold value.

In a case where it is determined in step S3 that the amount of change in the posture of the portable terminal 11 is equal to or less than the threshold value, the processing proceeds to step S4. In step S4, the posture estimation unit 55 determines whether a state where the amount of change in posture is equal to or less than the threshold value has continued for a fixed period of time.

In a case where it is determined in step S4 that a state where the amount of change in posture is equal to or less than the threshold value has not continued for a fixed period of time, the processing returns to step S2, and the subsequent processing is performed.

On the other hand, in a case where it is determined in step S4 that a state where the amount of change in posture is equal to or less than the threshold value has continued for a fixed period of time, the posture estimation unit 55 fixedly decides posture information, and the processing proceeds to step S5.

In step S5, the communication unit 56 transmits equipment information and posture information to the information processing device 14.

Thereafter, in step S6, the communication unit 56 determines whether an identification code transmitted from the information processing device 14 has been received.

In a case where it is determined in step S6 that the identification code has not been received, the processing proceeds to step S7. In step S7, the communication unit 56 determines whether a time-out time has elapsed.

In a case where it is determined in step S7 that the time-out time has not elapsed, the processing returns to step S6, and the portable terminal 11 waits for the transmission of the identification code until the time-out time elapses.

In a case where it is determined in step S7 that the time-out time has elapsed, the processing is terminated.

On the other hand, in a case where it is determined in step S6 that the identification code has been received, the processing proceeds to step S8. In step S8, the identification code encoding unit 57 performs encoding processing on the received identification code and generates a flashing pattern.

In step S9, the proximity sensor 58 outputs a flashing pattern of infrared light from the infrared light source 31.

In step S10, the communication unit 56 determines whether a registration completion notification transmitted from the information processing device 14 has been received.

In a case where it is determined in step S10 that the registration completion notification has been received, the processing is terminated.

On the other hand, in a case where it is determined in step S10 that the registration completion notification has not been received, the processing returns to step S7, and the subsequent processing is performed. That is, processing for outputting a flashing pattern of infrared light is continuously executed until the time-out time elapses or until the registration completion notification is received.

Operation of Information Processing Device 14

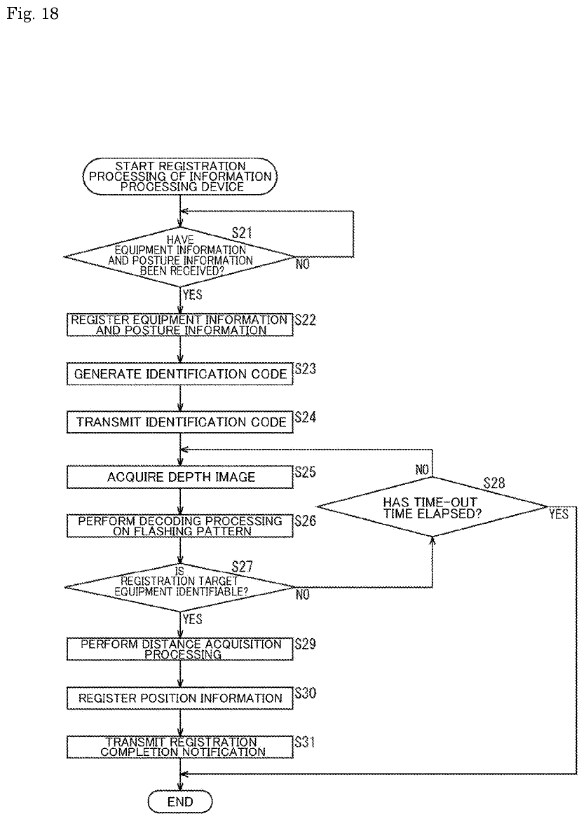

Next, registration processing of the information processing device 14 will be described with reference to a flowchart of FIG. 18.

The registration processing in FIG. 18 is a series of processing for registering display control information in the installation information database.

In step S21, the communication unit 71 determines whether equipment information and posture information transmitted from the portable terminal 11 have been received, and waits until it is determined that the equipment information and the posture information have been received. Note that the equipment information and the posture information are transmitted in the portable terminal 11 in the processing of step S5 in FIG. 17.

In a case where it is determined in step S21 that the equipment information and the posture information have been received, the processing proceeds to step S22. In step S22, the communication unit 71 supplies the equipment information and the posture information to the installation information storage unit 72 and registers the information in the installation information database.

In step S23, the identification code generation unit 73 generates an identification code based on key information associated with the registered equipment information.

In step S24, the communication unit 71 transmits an identification code to the portable terminal 11. The identification code is received in the portable terminal 11 before the processing of step S6 in FIG. 17.

In step S25, the position information acquisition unit 74 acquires a depth image from the infrared stereo camera 13 and waits until infrared light is detected in the depth image. In a case where infrared light has been detected, the processing proceeds to step S26.

In step S26, the identification code decoding unit 91 performs decoding processing on the flashing pattern and decodes the identification code.

In step S27, the position information acquisition unit 74 determines whether registration target equipment is identifiable by using the identification code decoded by the identification code decoding unit 91. For example, in a case where the identification code acquired from the installation information storage unit 72 and the identification code decoded by the identification code decoding unit 91 match each other, it is determined that registration target equipment such as the smart speaker as the electrical equipment 21 is identifiable.

In a case where it is determined in step S27 that registration target equipment is not identifiable, the processing proceeds to step S28. In step S28, the communication unit 71 determines whether a time-out time has elapsed.

In a case where it is determined in step S28 that the time-out time has elapsed, the processing is terminated.

In a case where it is determined in step S28 that the time-out time has not elapsed, the processing returns to step S25, and the subsequent processing is performed.

On the other hand, in a case where it is determined in step S27 that registration target equipment is identifiable, the processing proceeds to step S29. In step S29, the position detection unit 92 calculates coordinates of the center of gravity of a bright spot of infrared light which is shown in a depth image through bright spot detection. The distance estimation unit 93 calculates a distance from the position of the bright spot to a position where the infrared stereo camera 13 is installed, based on a brightness value of the bright spot shown in the depth image.

In step S30, the position information acquisition unit 74 generates position information of a projection plane based on a calculation result obtained by the position detection unit 92 and a calculation result obtained by the distance estimation unit 93. In addition, the position information acquisition unit 74 supplies the position information to the installation information storage unit 72 and registers the position information in the installation information database in association with equipment information of the registration target equipment identified using the identification code.

In step S31, the communication unit 71 transmits a registration completion notification to the portable terminal 11. The registration completion notification is received in the portable terminal 11 before the processing of step S10 in FIG. 17.

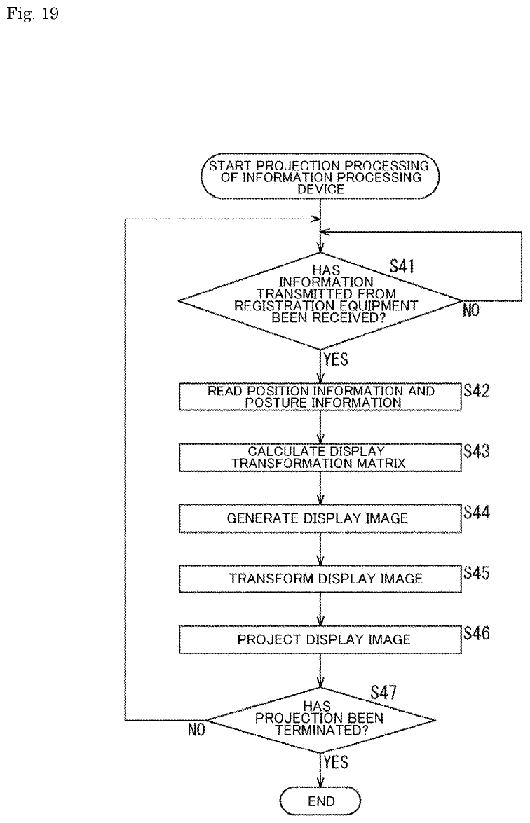

Subsequently, projection processing of the information processing device 14 will be described with reference to a flowchart of FIG. 19.

The projection processing in FIG. 19 is a series of processing for projecting display information provided from registration target equipment based on registered display control information.

In step S41, the communication unit 71 determines whether the display information transmitted from the registration target equipment such as the smart speaker as the electrical equipment 21 has been received, and waits until it is determined that the display information has been received.

In a case where it is determined in step S41 that the display information has been received, the processing proceeds to step S42. In step S42, the position and posture processing unit 77 reads position information and posture information from the installation information storage unit 72. In addition, the position and posture processing unit 77 reads system installation information from the system installation information storage unit 75.

In step S43, the position and posture processing unit 77 calculates a display transformation matrix based on the position information, the posture information, and the system installation information.

In step S44, the display processing unit 78 generates a display image based on the display information.

In step S45, the display processing unit 78 transforms the display image into a display image of a projector image coordinate system by using the display transformation matrix.

In step S46, the display processing unit 78 supplies the display image of the projector image coordinate system to the projector 12 and projects the display image onto the projector 12.

In step S47, the display control unit 76 determines whether the projection has been terminated. For example, in a case where it is detected that the power supply of the registration target equipment such as the smart speaker as the electrical equipment 21 has been turned off, it is determined that the projection has been terminated.

In a case where it is determined in step S47 that the projection has not been terminated, the processing returns to step S41, and the subsequent processing is performed.

In a case where it is determined in step S47 that the projection has been terminated, the processing is terminated.

By the above-described processing, the information processing device 14 can detect posture information of a projection plane without relying on object recognition using an image captured by a camera.

The information processing device 14 can detect position information and posture information of a projection plane by suppressing the influence of resolution of the camera, the influence of the installation position of the camera, and the like even when an imaging range of the camera is wide.

<5. Modification Example>

Information Registered in Installation Information Database

A shape such as irregularities of a projection plane may be registered in the installation information database in association with installation information.

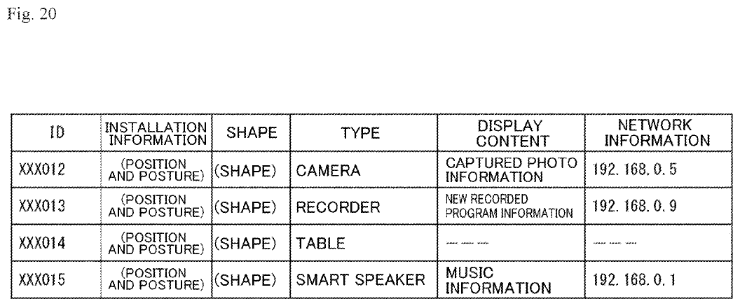

FIG. 20 is a diagram showing another schema example of an installation information database.

In FIG. 20, a “shape” is associated with the “ID”, the “installation position”, the “type”, the “display information”, and the “network information” described with reference to FIG. 12. The “shape” indicates a three-dimensional shape of a projection plane.

For example, information indicating the shape of the projection plane which is acquired using the portable terminal 11 is registered in association with equipment information, position information of the projection plane, and posture information of the projection plane.

Thereby, it is possible to display display information in accordance with a shape such as irregularities of a projection plane. For example, a smart speaker as registration target equipment serves as equipment which is a providing source of display information, and a housing thereof having a cylindrical shape also serves as a projection plane, whereby it is possible to display a display image projected by the projector 12.

System Configuration

In the above description, the information processing device 14 is provided as a device of a housing separate from the portable terminal 11, the projector 12, and the infrared stereo camera 13, but all or some of the functions of the information processing device 14 may be implemented in the projector 12.

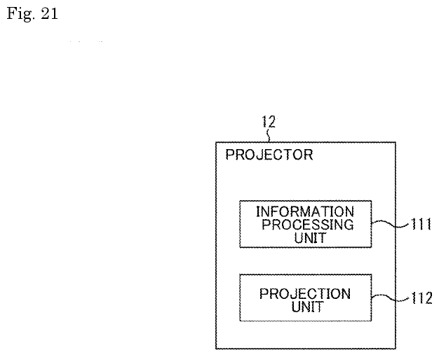

FIG. 21 is a block diagram showing a configuration example of the projector 12.

As shown in FIG. 21, the projector 12 includes an information processing unit 111 and a projection unit 112.

For example, the information processing unit 111 is provided with all of the components of the information processing device 14 described with reference to FIG. 11. The information processing unit 111 controls the entire projector 12 and projects a display image based on registered display control information.

The projection unit 112 projects a display image under the control of the information processing unit 111.

Note that the information processing unit 111 may be provided with some of the components of the information processing device 14, and some of the remaining components of the information processing device 14 may be provided in another device.

Infrared Stereo Camera 13 and Infrared Light Source 31

Instead of the infrared stereo camera 13, a receiver including a plurality of antennas corresponding to proximity wireless communication such as Bluetooth 5.1 may be provided in the vicinity of the projector 12. In this case, instead of the infrared light source 31, a transmitter corresponding to proximity wireless communication such as Bluetooth 5.1 is provided in the portable terminal 11.

The receiver can detect the position of the transmitter through proximity wireless communication with the transmitter. Information indicating the position of the transmitter which is detected by the receiver is supplied to the information processing device 14, and is registered in the installation information database as position information of a projection plane.

Instead of the infrared stereo camera 13, a camera may be provided in the vicinity of the projector 12. In a case where a distance between the camera and the portable terminal 11 is short, a marker displayed on the display of the portable terminal 11 is detected by the camera, and thus position information of a projection plane may be acquired.

Instead of the infrared stereo camera 13, position information of a projection plane may be acquired using a wearable device such as AR glass. In this case, the information processing device 14 calculates the position of the infrared light source 31 of the portable terminal 11 in the world coordinate system, based on the position of the wearable device which is estimated by the wearable device.

Parameters affecting the detection of an exposure time of the infrared stereo camera 13, or the like may be adjusted in accordance with a detected state of an infrared light source.

Notification of Detected State

In a case where infrared light is not detected by the infrared stereo camera 13 in a state where infrared light has to be detected such as a state where a flashing pattern of infrared light is output from the infrared light source 31, being unable to detect infrared light may be displayed on the display of the portable terminal 11.

Designation of Region of Projection Plane

A region of a projection plane may be designated by a plurality of portable terminals 11 that are placed on the projection plane. In this case, the positions of a plurality of points are detected at once by infrared light output by infrared light sources 31 provided in the plurality of portable terminals 11. A display image is projected so that a region formed by the detected positions of the plurality of points is registered as a projection plane and fits into the projection plane.

The portable terminal 11 is moved along a surface having a complex shape, and thus a region may be designated as a projection plane.

Posture Sensor

Information indicating the posture of the electrical equipment 21 as registration target equipment which is estimated based on sensor data obtained from a posture sensor provided in the electrical equipment 21 may be registered in an installation information database as posture information of a projection plane.

Projector 12

Instead of the projector 12 installed at a ceiling or the like, a drive type projector may be used. In this case, the information processing device 14 calculates a display transformation matrix based on the position and posture of the drive type projector in the world coordinate system.

Based on display control information, not only projection of the projector 12 may be controlled, but also sound transmission of a speaker may be controlled. In this case, instead of position information of a projection plane, position information of an output target is registered in the installation information database. In addition, the directivity of the speaker is adjusted based on the position information of the output target, and a sound is transmitted toward the position of the output target.

Acquisition of Equipment Information

The portable terminal 11 and the electrical equipment 21 may be provided with a communication module that supports Bluetooth (registered trademark). The portable terminal 11 can acquire equipment information from the electrical equipment 21 as registration target equipment through Bluetooth communication with the registration target equipment.

For example, equipment or the like which is paired with the portable terminal 11 by Bluetooth is selected, and position information and posture information of a projection plane are registered.

In a case where the portable terminal 11 and the electrical equipment 21 are connected to each other through a network such as the Internet or a wireless LAN, equipment information may be transmitted from the electrical equipment 21 as registration target equipment to the portable terminal 11 through the network.

Communication Method

Communication between the portable terminal 11 and the information processing device 14 may be performed not only through wireless communication through a network such as Wi-Fi but also through proximity wireless communication such as Bluetooth.

Display information provided from the electrical equipment 21 as registration target equipment may be acquired by the information processing device 14 through equipment, such as the portable terminal 11, which can be connected to a network.

Position of Registration Target Equipment and Position of Projection Plane

Although a case where display information is projected in the vicinity of a position where the electrical equipment 21 as registration target equipment is placed has been described above, a projection plane may be set at a position irrelevant to the position where the electrical equipment 21 as registration target equipment is placed.

For example, the portable terminal 11 is placed on a wall surface, and thus a portion of the region of the wall surface is registered in the installation information database as the position of the projection plane. Pieces of information of various pieces of equipment may be collectively displayed on the wall surface.

Computer

The series of processing described above can be executed by hardware or software. When the series of processing is performed by software, a program for the software is embedded in dedicated hardware to be installed from a program recording medium to a computer or a general-purpose personal computer.

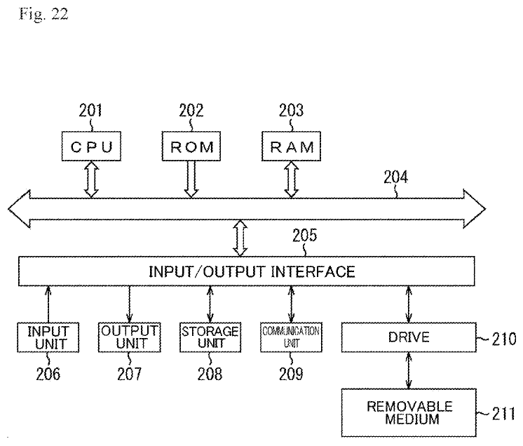

FIG. 22 is a block diagram showing an example of a configuration of hardware of a computer that executes a program to perform the above-described series of processing.

A central processing unit (CPU) 201, a read only memory (ROM) 202, and a random access memory (RAM) 203 are connected to each other via a bus 204.

An input/output interface 205 is further connected to the bus 204. An input unit 206 including a keyboard and a mouse and an output unit 207 including a display and a speaker are connected to the input/output interface 205. In addition, a storage unit 208 including a hard disk, a non-volatile memory, and the like, a communication unit 209 including a network interface and the like, and a drive 210 that drives a removable medium 211 are connected to the input/output interface 205.

In the computer configured as described above, the CPU 201 performs the above-described series of processing, for example, by loading a program stored in the storage unit 208 on the RAM 203 via the input/output interface 205 and the bus 204 and executing the program.

The program executed by the CPU 201 is recorded on, for example, the removable medium 211 or is provided via a wired or wireless transfer medium such as a local area network, the Internet, or digital broadcast to be installed in the storage unit 208.

Note that the program executed by the computer may be a program that performs processing chronologically in the order described in the present specification or may be a program that performs processing in parallel or at a necessary timing such as a calling time.

Others

Also, in the present specification, the system is a set of a plurality of components (devices, modules (parts), etc.), and it does not matter whether or not all the components are in the same housing. Accordingly, a plurality of devices accommodated in separate casings and connected via a network and a single device accommodating a plurality of modules in a single casing are all a system.

The effects described in the present specification are merely examples and are not intended as limiting, and other effects may be obtained.

The embodiments of the present technology are not limited to the above-described embodiments, and various changes can be made without departing from the gist of the present technology.

For example, the present technology can have a configuration of cloud computing in which one function is shared by a plurality of devices via a network and processed jointly.

In addition, each step described in the above flowchart can be executed by one device or shared by a plurality of devices.

Further, in a case in which one step includes a plurality of processes, the plurality of processes included in the one step can be executed by one device or shared and executed by a plurality of devices.

<Example of Combination of Configurations>

The present technology can be configured as follows.

(1)

An information processing device including:

a registration unit configured to register display control information for displaying display information on a projection plane, the display control information being generated based on sensor data obtained from a sensor provided in first equipment installed at the projection plane; and

a display control unit configured to project the display information onto the projection plane and display the display information based on the display control information.

(2)

The information processing device according to (1),

wherein the registration unit registers the display control information in association with equipment which is a providing source of the display information.

(3)

The information processing device according to (2),

wherein the display control information includes installation information including information indicating at least any one of a position and a posture of the projection plane.

(4)

The information processing device according to (3),

wherein the display control unit displays the display information at a specific position on the projection plane, based on the installation information.

(5)

The information processing device according to (3) or (4),

wherein the installation information includes information indicating the posture of the projection plane which is estimated based on sensor data obtained from a posture sensor provided in the first equipment.

(6)

The information processing device according to (5),

wherein the posture sensor is a sensor including at least any one of an inertial sensor and a geomagnetic sensor.

(7)

The information processing device according to any one of (3) to (6),

wherein the installation information includes information indicating the position of the projection plane which is estimated based on a detection result of light emitted from a light source provided in the first equipment.

(8)

The information processing device according to (7),

wherein the light source is included in a proximity sensor, and the information processing device further includes a position information acquisition unit that estimates the position of the projection plane, based on a captured image obtained by imaging light emitted from the light source.

(9)

The information processing device according to (8), further including:

an identification information generation unit configured to generate identification information for identifying second equipment which is a registration target; and

a communication unit configured to transmit the identification information to the first equipment.

(10)

The information processing device according to (9), further including:

a decoding unit configured to decode a flashing pattern of light emitted from the light source, the flashing pattern being a pattern in which the identification information is encoded,

wherein the registration unit registers equipment information on the second equipment identified by the identification information and the installation information in association with each other.

( 11)

The information processing device according to (9) or (10),

wherein the communication unit receives the display information from the second equipment, and

the display control unit displays the display information received from the second equipment.

(12)

The information processing device according to (11), further including:

a display processing unit configured to perform processing for transforming a display image indicating the display information, based on the installation information,

wherein the display control unit projects and displays the display image transformed by the display processing unit.

(13)

The information processing device according to any one of (3) to (12),

wherein the installation information includes information indicating a region of the projection plane which is estimated based on a detection result of light emitted from a light source provided in the first equipment, and

the display control unit projects the display information within a range of the region of the projection plane.

(14)

The information processing device according to any one of (3) to (13),

wherein the installation information includes information indicating a shape of the projection plane.

(15)

The information processing device according to (11),

wherein the display information is acquired from the second equipment through the first equipment.

(16)

The information processing device according to (10),

wherein the equipment information is acquired through the first equipment that has performed proximity wireless communication with the second equipment.

(17)

The information processing device according to (16),

wherein the proximity wireless communication includes communication using Bluetooth (registered trademark).

(18)

The information processing device according to (10),

wherein the equipment information is acquired through the first equipment that has performed communication with the second equipment through a network.

(19)

The information processing device according to (12),

wherein the display processing unit performs processing for transforming the display image based on information indicating a position and a posture of a drive type projection device, and

the display control unit projects and displays the display image, which is transformed by the display processing unit, by the drive type projection device.

(20)

An information processing method including:

causing an information processing device to

register display control information for displaying display information on a projection plane, the display control information being generated based on sensor data obtained from a sensor provided in first equipment installed at the projection plane, and

project the display information onto the projection plane and display the display information based on the display control information.

### REFERENCE SIGNS LIST

11 Portable terminal

12 Projector

13 Infrared stereo camera

14 Information processing device

21 Electrical equipment

31 Infrared light source

51 NFC unit

52 Object information input unit

53 Object information storage unit

54 Posture sensor

55 Posture estimation unit

56 Communication unit

57 Identification code encoding unit

58 Proximity sensor

71 Communication unit

72 Installation information storage unit

73 Identification code generation unit

74 Position information acquisition unit

75 System installation information storage unit

76 Display control unit

77 Position and posture processing unit

78 Display control unit

91 Identification code decoding unit

92 Position detection unit

93 Distance estimation unit

111 Information processing unit

112 Projection unit

1. An information processing device comprising:
a registration unit configured to register display control information for displaying display information on a projection plane, the display control information being generated based on sensor data obtained from a sensor provided in first equipment installed at the projection plane; and
a display control unit configured to project the display information onto the projection plane and display the display information based on the display control information.

2. The information processing device according to claim 1,
wherein the registration unit registers the display control information in association with equipment which is a providing source of the display information.

3. The information processing device according to claim 2,
wherein the display control information includes installation information including information indicating at least any one of a position and a posture of the projection plane.

4. The information processing device according to claim 3,
wherein the display control unit displays the display information at a specific position on the projection plane, based on the installation information.

5. The information processing device according to claim 3,
wherein the installation information includes information indicating the posture of the projection plane which is estimated based on sensor data obtained from a posture sensor provided in the first equipment.

6. The information processing device according to claim 5,
wherein the posture sensor is a sensor including at least any one of an inertial sensor and a geomagnetic sensor.

7. The information processing device according to claim 3,
wherein the installation information includes information indicating the position of the projection plane which is estimated based on a detection result of light emitted from a light source provided in the first equipment.

8. The information processing device according to claim 7,
wherein the light source is included in a proximity sensor, and
the information processing device further comprises a position information acquisition unit that estimates the position of the projection plane, based on a captured image obtained by imaging light emitted from the light source.

9. The information processing device according to claim 8, further comprising:
an identification information generation unit configured to generate identification information for identifying second equipment which is a registration target; and
a communication unit configured to transmit the identification information to the first equipment.

10. The information processing device according to claim 9, further comprising:
a decoding unit configured to decode a flashing pattern of light emitted from the light source, the flashing pattern being a pattern in which the identification information is encoded,
wherein the registration unit registers equipment information on the second equipment identified by the identification information and the installation information in association with each other.

11. The information processing device according to claim 9,
wherein the communication unit receives the display information from the second equipment, and
the display control unit displays the display information received from the second equipment.

12. The information processing device according to claim 11, further comprising:
a display processing unit configured to perform processing for transforming a display image indicating the display information, based on the installation information,
wherein the display control unit projects and displays the display image transformed by the display processing unit. cm 13. The information processing device according to claim 3,
wherein the installation information includes information indicating a region of the projection plane which is estimated based on a detection result of light emitted from a light source provided in the first equipment, and
the display control unit projects the display information within a range of the region of the projection plane.

14. The information processing device according to claim 3,
wherein the installation information includes information indicating a shape of the projection plane.

15. The information processing device according to claim 11,
wherein the display information is acquired from the second equipment through the first equipment.

16. The information processing device according to claim 10,
wherein the equipment information is acquired through the first equipment that has performed proximity wireless communication with the second equipment.

17. The information processing device according to claim 16,
wherein the proximity wireless communication includes communication using Bluetooth (registered trademark).

18. The information processing device according to claim 10,
wherein the equipment information is acquired through the first equipment that has performed communication with the second equipment through a network.

19. The information processing device according to claim 12,
wherein the display processing unit performs processing for transforming the display image based on information indicating a position and a posture of a drive type projection device, and
the display control unit projects and displays the display image, which is transformed by the display processing unit, by the drive type projection device.

20. An information processing method comprising:
causing an information processing device to
register display control information for displaying display information on a projection plane, the display control information being generated based on sensor data obtained from a sensor provided in first equipment installed at the projection plane, and
project the display information onto the projection plane and display the display information based on the display control information.
